(19) United States
(12) Patent Application Publication
(10) Pub. No.: US 2021/0124995 A1
(43) Pub. Date: Apr. 29, 2021

(54) SELECTING TRAINING SYMBOLS FOR SYMBOL RECOGNITION

(71) Applicants: Hewlett-Packard Development Company, L.P., Spring, TX (US); Purdue Research Foundation, West Lafayette, IN (US)

(72) Inventors: Daniel Mas Montserrat, West Lafayette, IN (US); Qian Lin, Palo Alto, CA (US); Jan Allebach, Boise, ID (US); Edward John Delp, III, West Lafayette, IN (US)

(21) Appl. No.: 16/965,356

(22) PCT Filed: Jan. 31, 2018
(86) PCT No.: PCT/US2018/016211

§ 371 Date: Jul. 28, 2020

(51) Int. Cl. G06K 9/62; G06N 3/08; G06F 16/55; G06F 16/58

(52) U.S. Cl. CPC G06K 9/6256; G06K 9/6254; G06K 2209/25; G06F 16/55; G06F 16/58; G06N 3/08

(57) ABSTRACT

A query is submitted to a search engine, where the query includes an identification of a symbol. A bounding box is generated in an unlabeled image returned by the search engine in response to the query. A confidence score is also generated that indicates a likelihood of the symbol being present in a portion of the unlabeled image enclosed by the bounding box. The unlabeled image is selected as a training image for training a system to recognize the symbol, when the confidence score is above a predefined threshold.

### BACKGROUND

Visual media has become a powerful tool for sharing information. Often, a symbol, such as a logo, image, or text, may be present in the visual media. For instance, a social media user may post an image of himself drinking coffee from a cup that displays the logo for a particular coffee chain. The presence of the logo in the image, and in similar images, may provide unique brand insight for the coffee chain.

### BRIEF DESCRIPTION OF THE DRAWINGS

FIG. 1 depicts a high-level block diagram of an example symbol recognition system that can be trained to recognize symbols such as logos, images, text, and the like in images;

FIG. 2 illustrates a flowchart of an example method for training a symbol recognition system;

FIG. 3 is a flowchart of an example method for synthesizing training images for training a symbol recognition system;

FIG. 4A depicts an example starting image;

FIG. 4B depicts an example depth estimation that may be obtained from the example starting image of FIG. 4A;

FIG. 4C depicts an example image segmentation that may be obtained from the example starting image of FIG. 4A;

FIG. 4D depicts an example set of segments that may be selected from the example starting image of FIG. 4A;

FIG. 4E depicts an example symbol (e.g., a commercial logo) that may be inserted into the example starting image of FIG. 4A;

FIG. 4F depicts an example composite image that may be generated by inserting the example symbol depicted in FIG. 4E into a segment of the example starting image depicted in FIG. 4A;

FIG. 5 is a flowchart of an example method for training a symbol recognition system using unlabeled training data; and

FIG. 6 illustrates an example of an apparatus.

### DETAILED DESCRIPTION

The present disclosure broadly describes an apparatus, method, and non-transitory computer-readable medium for selecting training symbols for symbol recognition. As discussed above, visual media has become a powerful tool for sharing information. Often, a symbol, such as a logo, image, or text, may be present in the visual media, and the presence of the symbol may provide unique insight into the entity represented by the symbol.

Convolutional neural networks (CNNs) have shown to be effective in performing symbol recognition. However, the effectiveness of a CNN often depends on the amount of labeled training data that is available to train the CNN. Labeling of training data (e.g., images containing different symbols, including symbols of interest) is typically a manual process. This process can be time consuming as well as costly.

Examples of the present disclosure use unlabeled training data to train a symbol recognition system. In one example, the system may initially be trained using synthesized training images. The synthesized training images may be generated by strategically inserting symbols (e.g., images, logos, or text) into existing, unlabeled images. After the initial training, the system may be further trained using a bootstrapping process. The bootstrapping process uses a search engine to acquire existing images that include symbols, and the acquired images are then processed to recognize the symbols. The recognition process produces, for each image, a bounding box that identifies a region in the image where a symbol is detected. The bounding box is associated with a class (i.e., a specific symbol the system is trained to detect) and a confidence score indicating a confidence in the class identification. If the class matches the query used to drive the search engine, and the confidence score is above a threshold, then it is selected. From the set of selected bounding boxes, a fixed number of bounding boxes having highest confidence scores are chosen. The images containing the chosen bounding boxes are then fed back into the system for training, in order to fine-tune the system's detection capabilities. The recognition, selection of bounding boxes, and fine-tuning steps can be repeated any number of times, in that order, to further fine-tune the system's detection capabilities.

Within the context of the present disclosure, a “symbol” may refer to a logo, an image, or text that occurs in visual media. Thus, although examples of the present disclosure are discussed within the context of detecting logos, such examples can be extended to detecting other types of symbols, including text and images.

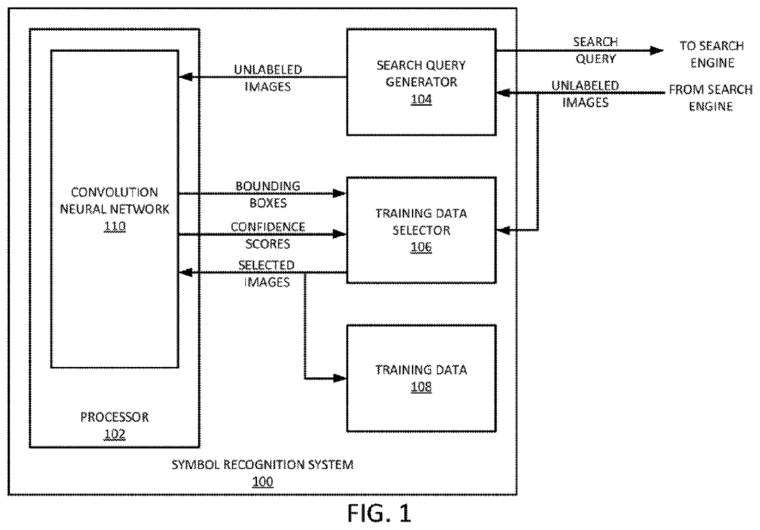

FIG. 1 depicts a high-level block diagram of an example symbol recognition system 100 that can be trained to recognize symbols such as logos, images, text, and the like in images. In one example, the symbol recognition system 100 generally comprises a processor 102, a search query generator 104, a training data selector 106, and a training data repository 108.

The processor 102 is configured to recognize symbols in input images. In one example, the processor 102 includes a convolutional neural network (CNN) 110 that is trained to recognize the symbols. In other examples, the CNN 110 may be replaced with another type of machine learning system, including another type of neural network. In one example the CNN 110 receives as input a plurality of images and produces as output a plurality of bounding boxes, where each bounding box is assigned a class that is associated with a symbol believed to be present in the portion of an image that is enclosed by the bounding box. The CNN 110 also produces for each bounding box a confidence score which indicates a likelihood that the class assigned to the bounding box is correct (i.e., that the symbol associated with the class is depicted in the bounding box). As discussed in further detail below, the training may be an iterative process in which the capabilities of the CNN 110 are progressively fine-tuned through successive iterations of the recognition process.

The search query generator 104 is configured to retrieve training data in the form of unlabeled images for the CNN 110. In one example, the search query generator 104 may formulate a search query that identifies a symbol that the CNN 110 is to be trained to recognize. The search query generator 104 may submit the search query to a search engine, which may return a plurality of unlabeled images (retrieved, e.g., from public sources over the Internet) in response to the search query. The search query generator 104 is further configured to forward the unlabeled images to the CNN 110 for production of the bounding boxes and confidence scores described above.

The training data selector is configured to select images for training of the CNN 110 based on the bounding boxes and confidence scores produced by the CNN 110. In one example, the training data selector feeds the selected images back into the CNN 110 as training data, e.g., in a feedback loop. The training data selector 106 may also store the selected images in the training data repository 108.

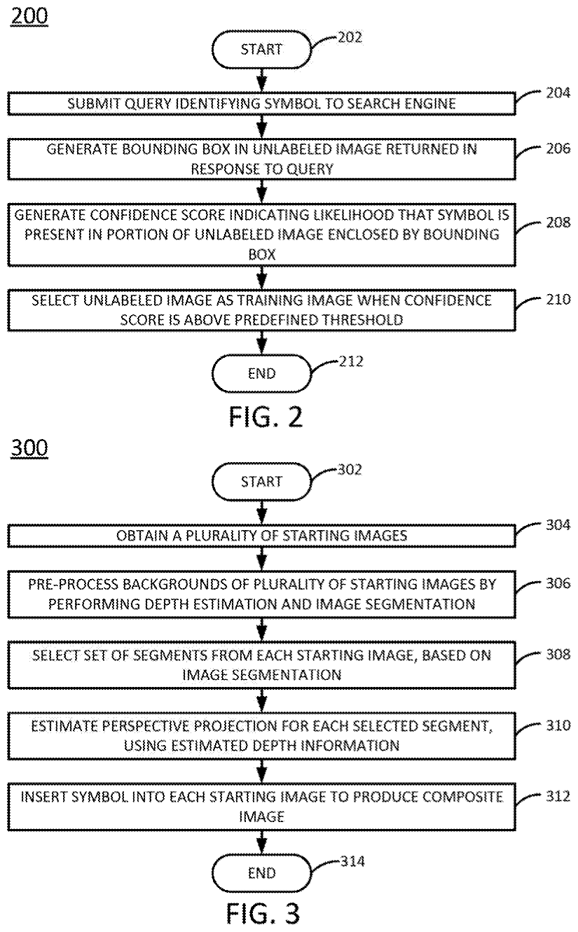

FIG. 2 illustrates a flowchart of an example method 200 for training a symbol recognition system. The method 200 may be performed, for example, by components of the system 100 illustrated in FIG. 1. As such, reference may be made in the discussion of FIG. 2 to various components of the system 100 to facilitate understanding. However, the method 200 is not limited to implementation with the system illustrated in FIG. 1.

The method 200 begins in block 202. In block 204, a query is submitted to a search engine. The query includes an identification of a symbol (e.g., a “target symbol”). For instance, the query may comprise a search string including the target symbol, such as a brand associated with the target symbol (e.g., “Brand X”), and a keyword describing a place or a product on which the target symbol may appear (e.g., “logo,” “ad,” “billboard,” “packaging,” “bottle,” “can,” “beer,” “shirt,” “hat,” “merchandising,” “event,” “building,” “headquarters,” “van,” “truck,” “airplane,” “shoes,” “store,” “shop,” “employees,” “office,” or “sign,” to name a few possibilities). As an example, a query targeting “Brand X” beer may comprise the search string “Brand X bottle.”

In block 206, a bounding box is generated in an unlabeled image returned by the search engine in response to the query. The bounding box indicates a region of the unlabeled image that is believed to contain the target symbol. Thus, the bounding box may be assigned a class indicating the target symbol that is believed to be contained within the bounding box. In one example, a symbol detection system, such as a CNN, may be used to detect the symbol in the unlabeled image and to generate the bounding box.

In block 208, a confidence score is generated. The confidence score indicates a likelihood of the symbol being present in a portion of the unlabeled image enclosed by the bounding box (i.e., a likelihood of the class assignment made in block 206 being correct). The confidence score may have a value falling in the range from zero to one.

In block 210, the unlabeled image is selected as a training image for training a system to recognize the symbol, when the confidence score is above a predefined threshold.

The method 200 ends in block 212. As discussed in greater detail below, blocks 206-210 of the method 200 may be repeated for a plurality of unlabeled images returned by the search engine.

FIG. 3 is a flowchart of an example method 300 for synthesizing training images for training a symbol recognition system. The method 300 may be performed, for example, by components of the system 100 illustrated in FIG. 1. As such, reference may be made in the discussion of FIG. 3 to various components of the system 100 to facilitate understanding. However, the method 300 is not limited to implementation with the system illustrated in FIG. 1.

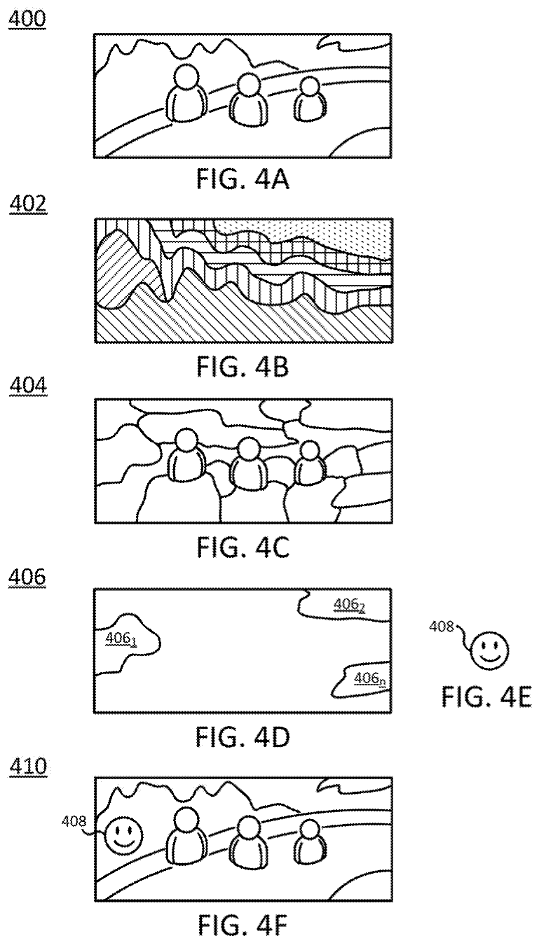

The method 300 begins in block 302. In block 304, a plurality of starting images is obtained. In one example, each starting image in the plurality of starting images is an image that lacks text or commercial logos. The plurality of starting images may be obtained, for example, by using a search engine to retrieve publicly available images from the Internet. FIG. 4A, for instance, depicts an example starting image 400.

In block 306, the backgrounds of the plurality of starting images are pre-processed. In one example, pre-processing of the background of a starting image includes performing depth estimation and image segmentation on the background. The depth may be estimated using a CNN. FIG. 4B, for instance, depicts an example depth estimation 402 that may be obtained from the example starting image 400 of FIG. 4A. The image segmentation may be performed using an edge detector. FIG. 4C, for instance, depicts an example image segmentation 404 that may be obtained from the example starting image 400 of FIG. 4A. In one example, the depth estimations and segmentation masks are precomputed.

In block 308, for each starting image, a set of segments from the image segmentation performed in block 306 is randomly selected. In one example, none of the randomly selected segments in the set of segments is smaller than 130 pixels×130 pixels. Each randomly selected segment in the set of segments represents a region of interest in the starting image, i.e., a region into which a symbol may be inserted. FIG. 4D, for instance, depicts an example set of segments 406₁-406ₙ (hereinafter collectively referred to as “segments 406” or individually referred to as a “segment 406”) that may be selected from the example starting image 400 of FIG. 4A.

In block 310, a perspective projection is estimated for each of the randomly selected segments in the set of segments. In one example, the perspective projection is estimated using the depth information estimated in block 306.

In block 312, a symbol is inserted into each of the starting images to produce a composite image. In one example, a plurality of different symbols is inserted into the plurality of starting images, so that the resultant composite images vary in terms of the symbols they depict. The symbols may comprise commercial logos for companies in a variety of different commercial sectors (e.g., food, clothing, automotive, transportation, technology, etc.). FIG. 4E, for instance, depicts an example symbol 408 (e.g., a commercial logo) that may be inserted into the example starting image 400 of FIG. 4A. FIG. 4F, for instance, depicts an example composite image 410 that may be generated by inserting the example symbol 408 depicted in FIG. 4E into a segment 406 of the example starting image 400 depicted in FIG. 4A. In one example, the symbols that are inserted into the starting images are extracted from publicly available images retrieved from the Internet (hereinafter referred to as “symbol images”). For instance, the alpha channel of a symbol image may be used to separate the symbol from the symbol image background. In the case where the symbol image does not include an alpha channel, the background may be assumed to be white. In one example, insertion of a symbol into a starting image may involve inserting up to three symbols into each segment of the starting image.

In one example, an alpha compositing technique is used to insert symbols into starting images in block 312. In this case, alpha values from the symbol and background of a symbol image are scaled by p and (1-p), respectively (where p is a random value selected uniformly from within a defined range, e.g., 0.5 to 1). For instance, insertion of a symbol may begin by applying a small jittering in the hue, saturation, value (HSV) color space of the symbol image (e.g., with a probability of 0.5). Random values selected uniformly from within a defined range (e.g., −10 to 10) are then applied to the hue, saturation, and value channels of the symbol image. A rotation of −90 or 90 degrees is then applied to the symbol image (e.g., with a probability of 0.3). A homographic transformation may then be applied to the symbol image. Application of the homographic transformation may use a binary mask to confirm that there is no overlap between symbols, and that a symbol remains with the intended segment of the starting image that was selected in block 308. The binary mask may be updated with the alpha channel of the symbol image each time a symbol is inserted into the starting image.

The method 300 ends in block 314.

The blocks of the method 300 may be repeated multiple times for each starting image. For instance, when starting with approximately 8,000 starting images and approximately 604 symbol images, the method 300 may produce as many as 280,000 composite images. In further examples, however, any number of composite images can be produced. The composite images may then be used to train a symbol recognition system, such as a CNN-based symbol recognition system, to classify symbols. For instance, the symbol recognition system could be trained to assign regions of a composite image to classes associated with logos or brands depicted in those regions.

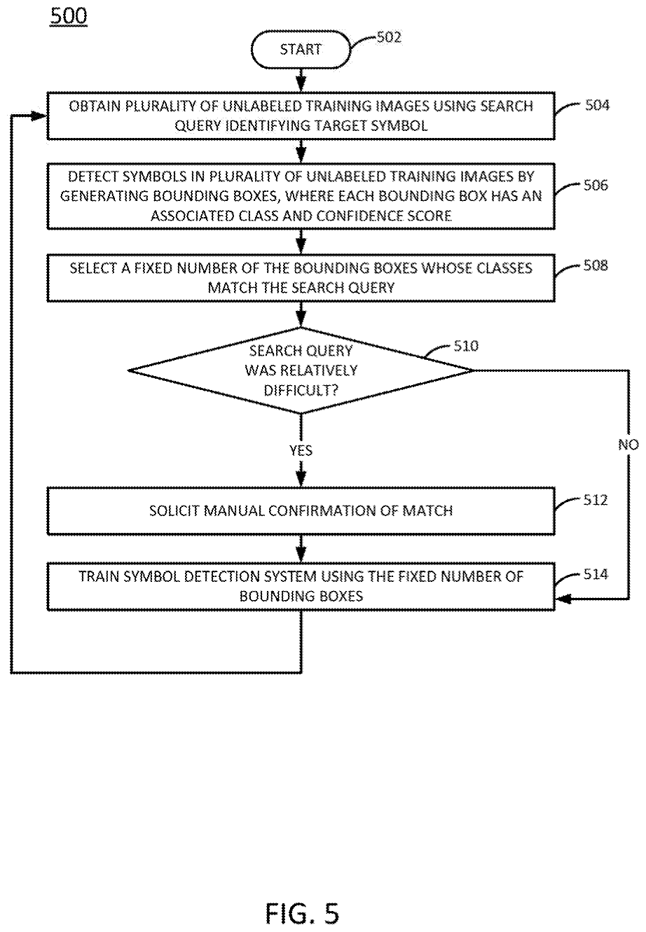

In one example, the method 300 may be used in conjunction with a bootstrapping process to train a symbol recognition system. For instance, the composite images produced by the method 300 could be used in a first iteration of a symbol recognition system, such as a CNN, for the purposes of initially training the system. A bootstrapping process as described in FIG. 5, below, could then be used in subsequent iterations of the symbol recognition system to fine-tune the system's detection capabilities and improve accuracy.

FIG. 5 is a flowchart of an example method 500 for training a symbol recognition system using unlabeled training data. In one example, the method 500 is a more detailed version of the method 200 described above in connection with FIG. 2. The method 500 may be performed, for example, by the components of the system 100 illustrated in FIG. 1. As such, reference may be made in the discussion of FIG. 5 to various components of the system 100 to facilitate understanding. However, the method 500 is not limited to implementation with the system illustrated in FIG. 1.

In one example, the method 500 is an iterative bootstrapping process that utilizes results from previous iterations to fine-tune subsequent iterations and improve the detection capabilities of the symbol recognition system.

The method 500 begins in block 502. In block 504, a plurality of unlabeled training images is obtained. In one example, the plurality of unlabeled training images is acquired by using an image search engine to retrieve publicly available images from the Internet. The search engine may search based a query that targets a specific symbol (e.g., a specific logo). For instance, a search query may comprise a search string including a brand associated with the target symbol and a keyword describing a place or a product on which the target symbol may appear (e.g., “logo,” “ad,” “billboard,” “packaging,” “bottle,” “can,” “beer,” “shirt,” “hat,” “merchandising,” “event,” “building,” “headquarters,” “van,” “truck,” “airplane,” “shoes,” “store,” “shop,” “employees,” “office,” or “sign,” to name a few possibilities). As an example, a query targeting “Brand X” beer may comprise the search string “Brand X bottle.” In one example, a predefined limit is set on the number of training images that is retrieved in response to a search query (e.g., no more than 100 training images per query).

In one example, the relative difficulty of the search query may increase with subsequent iterations of block 504, where the “ease” or “difficulty” of a search query refers to how easy or difficult it is for the human eye to see the target symbol in the search results returned by the search query (e.g., how prominently the target symbol is likely to be displayed in a returned image). For instance, the first iteration of block 504 may use a search query such as “Brand X logo,” “Brand X bottle,” or “Brand X ad,” while subsequent iterations of block 504 may use a search query such as “Brand X headquarters” or “Brand X building.”

In block 506, symbols are detected in the plurality of unlabeled training images using a symbol detection system. In one example, the symbol detection system is a CNN. In one example, the symbol detection system is initially trained using the training images produced by the method 300, described above. As described in connection with FIG. 2, symbol detection in accordance with block 506 involves producing a bounding box and a confidence score for each training image. The bounding box indicates a region of the training image that is believed to contain a symbol. The bounding box is assigned a class indicating the symbol (e.g., logo) that is believed to be contained within the bounding box. The confidence score indicates the likelihood that the class assigned to the bounding box is correct (i.e., the likelihood of the symbol being present in the bounding box). The confidence score may have a value falling in the range from zero to one.

In block 508, a number of the bounding boxes whose assigned classes match the search query used in block 504 (e.g., the classes match the target logo) are selected. For instance, if the class assigned to a bounding box is “Brand X logo” when the search query was “Brand X bottle,” then the bounding box may be selected. In one example, a first plurality of bounding boxes for which the confidence score associated with the class assignment at least meets a predefined threshold (e.g., 0.1 or higher) is first identified; a second plurality of bounding boxes for which the confidence score falls below the predefined threshold is discarded. Then, a fixed number N of bounding boxes from the first plurality of bounding boxes is selected for each class. This fixed number may be user configurable. In one example, the N bounding boxes for which the confidence score is highest in each class are selected.

In one example, subsequent iterations of block 508 may increase the fixed number N, so that a greater number of bounding boxes is selected. In one example, each time the method 500 iterates through block 508, the fixed number N increases. The fixed number N can be incremented linearly (e.g., select the one bounding box with the highest confidence score during the first iteration, the two bounding boxes with the highest confidence scores at the second iteration, the three bounding boxes with the highest confidence scores at the third iteration, and so on), or exponentially (e.g., select the one bounding box with the highest confidence score during the first iteration, the two bounding boxes with the highest confidence scores at the second iteration, the four bounding boxes with the highest confidence scores at the third iteration, and so on), or in any other manner.

In block 510, it is determined whether the search query used in block 504 was relatively difficult (i.e., whether the target symbol was difficult to see with the human eye in the returned images). If it is determined in block 510 that the search query was difficult, then the method 500 may proceed to block 512.

In block 512, manual confirmation of the match by a human operator is solicited. The manual confirmation allows the human operator to identify, for the symbol detection system, any bounding boxes in the fixed number N of selected bounding boxes that were incorrectly selected (e.g., for which the portion of the image contained in the bounding box does not display the target logo). If a bounding box is discarded through manual confirmation, then a replacement bounding box may be selected from among those bounding boxes that were not selected in block 508. The method 500 may then proceed to step 514.

If, however, is determined in block 510 that the search query was not difficult, then the method 500 may proceed directly to block 514. In block 514, the symbol detection system is trained using the fixed number N of selected bounding boxes. The training in block 514 fine tunes the detection capabilities of the symbol detection system.

The method 500 then returns to block 504 and obtains a new plurality of unlabeled training images using a new search query. For instance, a more difficult search query may be used to search for more images containing the target symbol. The method 500 then proceeds as described above to perform subsequent iterations of blocks 504-514, until a stopping point is reached. The stopping point may be reached, for example, when there are no more search queries to be run, or when a human operator determines that the symbol detection system has been sufficiently trained.

It should be noted that although not explicitly specified, some of the blocks, functions, or operations of the methods 200, 300, and 500 described above may include storing, displaying and/or outputting for a particular application. In other words, any data, records, fields, and/or intermediate results discussed in the method can be stored, displayed, and/or outputted to another device depending on the particular application. Furthermore, blocks, functions, or operations in FIGS. 2, 3, and 5 that recite a determining operation, or involve a decision, do not necessarily imply that both branches of the determining operation are practiced.

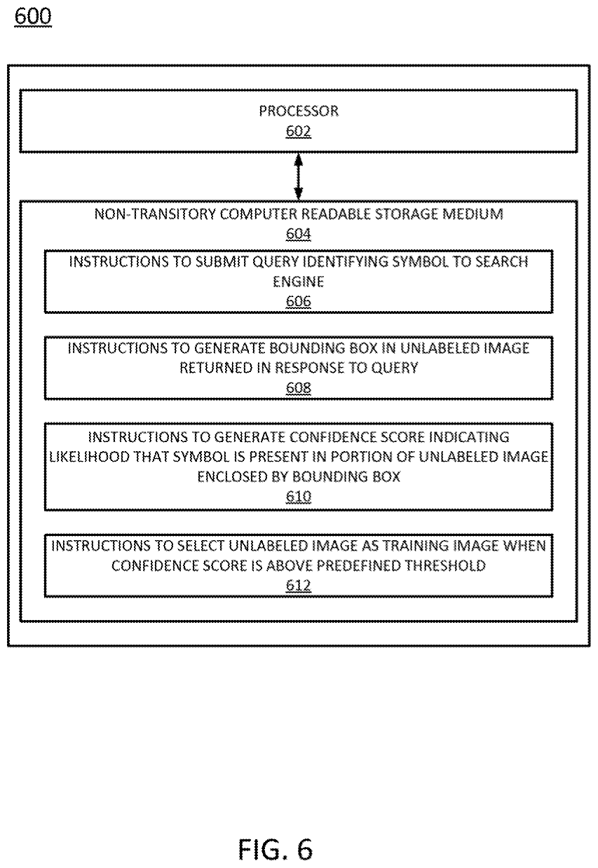

FIG. 6 illustrates an example of an apparatus 600. In one example, the apparatus 600 may be the apparatus 100. In one example, the apparatus 600 may include a processor 602 and a non-transitory computer readable storage medium 604. The non-transitory computer readable storage medium 604 may include instructions 606, 608, and 610 that, when executed by the processor 602, cause the processor 602 to perform various functions.

The instructions 606 may include instructions to submit a query identifying a symbol to a search engine. The instructions 608 may include instructions to generate a bounding box in an unlabeled image returned in response to the query. The instructions 610 may include instructions to generate a confidence score indicating a likelihood that the symbol is present in a portion of the unlabeled image enclosed by the bounding box. The instructions 612 may include instructions to select the unlabeled image as a training image for a symbol recognition system to recognize the symbol when the confidence score is above a predefined threshold.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

1. A method, comprising:
submitting a query to a search engine, wherein the query includes an identification of an image;
generating, in an unlabeled image returned by the search engine in response to the query, a bounding box;
generating a confidence score that indicates a likelihood of the image being present in a portion of the unlabeled image enclosed by the bounding box; and
selecting the unlabeled image as a training image for training a system to recognize the image, when the confidence score is above a predefined threshold.

2. The method of claim 1, wherein the image is a logo.

3. The method of claim 1, wherein the unlabeled image is a publicly available image retrieved from the Internet.

4. The method of claim 1, wherein the generating the bounding box and the generating the confidence score are performed by the system.

5. The method of claim 1, wherein the system comprises a convolutional neural network.

6. The method of claim 1, wherein the unlabeled image is selected from among a plurality of unlabeled images returned by the search engine, and wherein the confidence score associated with the bounding box is highest among a plurality of confidence scores associated with a plurality of bounding boxes generated in the plurality of unlabeled images.

7. The method of claim 1, further comprising:
repeating the submitting the query, the generating the bounding box, the generating the confidence score, and the selecting the unlabeled image, using a new query that includes the identification of the image, wherein the system uses the unlabeled image as a training image during the repeating.

8. The method of claim 7, wherein the image is less prominently displayed in a new unlabeled image returned by the search engine in response to the new query than in the unlabeled image.

9. The method of claim 1, further comprising:
soliciting confirmation from a human operator that the image is depicted in the bounding box, prior to the selecting.

10. The method of claim 1, wherein the system is trained, prior to submitting the query, using a plurality of composite images in which the image was inserted into an image that previously lacked the image.

11. An apparatus, comprising:
a search query generator to submit a query to a search engine, wherein the query includes an identification of an image;
a processor to generate, in an unlabeled image returned by the search engine in response to the query, a bounding box and to generate a confidence score that indicates a likelihood of the image being present in a portion of the unlabeled image enclosed by the bounding box; and
a training data selector to select the unlabeled image as a training image for training a system to recognize the image, when the confidence score is above a predefined threshold.

12. The method of claim 11, wherein the processor comprises a convolutional neural network.

13. A non-transitory machine-readable storage medium encoded with instructions executable by a processor, the machine-readable storage medium comprising:
instructions to submit a query to a search engine, wherein the query includes an identification of an image;
instructions to generate, in an unlabeled image returned by the search engine in response to the query, a bounding box;
instructions to generate a confidence score that indicates a likelihood of the image being present in a portion of the unlabeled image enclosed by the bounding box; and
instructions to select the unlabeled image as a training image for training a system to recognize the image, when the confidence score is above a predefined threshold.

14. The non-transitory machine-readable storage medium of claim 13, wherein the system comprises a convolutional neural network.

15. The non-transitory machine-readable storage medium of claim 13, wherein the instructions further comprise:
instructions to repeat submitting the query, generating the bounding box, generating the confidence score, and selecting the unlabeled image, using a new query that includes the identification of the image, wherein the system uses the unlabeled image as a training image during the repeating.
